(19) United States
(12) Patent Application Publication
(10) Pub. No.: US 2015/0118409 A1
(43) Pub. Date: Apr. 30, 2015

(54) RELEASE FILM WITH ENHANCED MECHANICAL PROPERTIES AND METHOD IN PREPARING THEREOF

(71) Applicant: Nano and Advanced Materials Institute Limited, HKUST (HK)

(72) Inventors: Mimi Hetti, Shatin (HK); Wing Cheong Lai, Hung Hom (HK); Chui Wan Tse, New Territories (HK); Chor Keung Cheung, New Territories (HK); Yin Fai Lee, HKUST (HK); Yin Man Lai, HKUST (HK); Wing Yi Kung, HKUST (HK)

(73) Assignee: Nano and Advanced Materials Institute Limited, HKUST (HK)

(21) Appl. No.: 14/063,465

(22) Filed: Oct. 25, 2013

(51) Int. Cl. C09D 7/12; C08K 9/04

(52) U.S. Cl. CPC C09D 7/1225; C08K 9/04
USPC 427/496; 106/287.17; 427/385.5

(57) ABSTRACT

This invention relates to a method of preparing a coating formulation for processing a release paper and a method of processing a release paper with the coating formulation for use in synthetic leather industry. The coating formulation includes MEMO-surface modified nanoparticles and an acrylate composition. The release paper processed by the coating formulation is found to demonstrate an improved abrasion resistance.

### FIELD OF THE INVENTION

This invention relates to a method of preparing a coating formulation for processing a release sheet and a method of processing a release sheet, and particularly, but not exclusively, to method of preparing a coating formulation for processing a release paper and a method of processing a release paper for use in synthetic leather industry.

### BACKGROUND OF THE INVENTION

Release film, also known as release liner, is a paper or plastic based sheet material capable of providing a release effect against self-adhesive or pressure sensitive adhesive materials such as tapes and labels. It also plays an important role in the manufacturing of synthetic fabric or leather industry, in which polymeric materials such as soften polyurethane (PU) or poly vinyl chloride (PVC) are casted and molded on a textured film or liner so that upon cooling, the cured PU and PVC can be readily released from, and be embossed with the desired texture of the release film or liner. For example, the cured polymer can be embossed with texture of animal skins to mimic the texture of leathers, or with other patterns for decorative purposes.

The release effect of a release film is generally achieved by coating one or both sides of the film with a polymeric formulation including a releasing agent. To increase mechanical strength and durability, the release film is usually coated with nanoparticles such as silica. The polymeric coating is of particular importance for the release film being used in the synthetic leather industry, as the manufacturing process of casting and drying the melted polymer would usually involve high temperature which could be up to, for example, 200° C. Undesirable curling, softening, becoming brittle or even breakage of the release film may occur after repeated use, which will result in the failure of the molding process or deformation of the molded synthetic leather.

It is an object of the present invention to provide a release film with enhanced mechanical properties and a method of producing such release film in which the aforesaid shortcomings are mitigated or at least to provide a useful alternative.

### SUMMARY OF THE INVENTION

In accordance with a first aspect of the present invention, there is provided a method of preparing a coating formulation for use in processing a release sheet, comprising steps of providing nanoparticles; treating the nanoparticles to give surface-modified nanoparticles; and introducing the surface-modified nanoparticles into a monomer composition.

In an embodiment of the first aspect, the method further comprising step of purifying the surface-modified nanoparticles after step b.

In an embodiment of the first aspect, the method further comprising step of dispersing the surface-modified nanoparticles into a solvent to form a surface-modified nanoparticles dispersion prior to step c.

In an embodiment of the first aspect, the monomer composition comprises at least one of acrylate monomers, acrylate oligomers, releasing agent or a mixture thereof.

In an embodiment of the first aspect, the treating step comprises surface modifying the nanoparticles by using saline coupling agent.

In an embodiment of the first aspect, the saline coupling agent comprises 3-(trimethoxysilyl) propyl methacrylate.

In an embodiment of the first aspect, the treating step comprises introducing acrylate groups onto surface of the nanoparticles.

In an embodiment of the first aspect, the nanoparticles are selected from a group consisting of aluminum dioxide, silicon dioxide and zinc oxide nanoparticles and a mixture thereof.

In an embodiment of the first aspect, the nanoparticles are of less than or equal to about 3 wt % in the monomer composition.

In an embodiment of the first aspect, the method further comprising a step of removing the solvent after the incorporating step.

In an embodiment of the first aspect, the solvent is iso-propanol.

In an embodiment of the first aspect, the surface-modified nanoparticles are of a diameter of about 10 nm to 120 nm.

In an embodiment of the first aspect, the coating formulation after step c is of a viscosity of about 700 to 1000 cP at ambient condition.

In an embodiment of the first aspect, the nanoparticles are spherical, rod-like, a string of pearl like, or a mixture thereof.

In accordance with a second aspect of the present invention, there is provided a method of processing a release sheet, comprising coating a coating formulation onto a surface of a sheet substrate; curing the coating formulation to form a polymer-coated sheet substrate; wherein the coating formulation is prepared by the method according to claim 1.

In an embodiment of the second aspect, the curing step comprises radiating of electron beam or ultra-violet light.

### BRIEF DESCRIPTION OF THE DRAWINGS

FIG. 1 shows processing steps of the release paper using electron beam coater in accordance with an embodiment of the present invention.

FIG. 2 shows the reaction mechanism for the surface modification of alumina nanoparticles to form the 3-(trimethoxysilyl) propyl methacrylate (MEMO)-modified alumina nanoparticles in accordance with an embodiment of the present invention.

FIGS. 3A and 3B show transmission electron micrograph (TEM) images of spherical silicon dioxide (SiO₂) nanoparticles in accordance with an embodiment of the present invention.

FIG. 3C shows a SEM-energy-dispersive X-ray spectroscopy (EDX) image of spherical silicon dioxide (SiO₂) nanoparticles in accordance with an embodiment of the present invention.

FIGS. 4A and 4B show TEM images of rod-shape SiO₂ nanoparticles in accordance with an embodiment of the present invention.

FIG. 4C shows a SEM-EDX images of rod-shape SiO₂ nanoparticles in accordance with an embodiment of the present invention.

FIGS. 5A and 5B show TEM images of ZnO nanoparticles in accordance with an embodiment of the present invention.

FIG. 5C shows a SEM-EDX image of ZnO nanoparticles in accordance with an embodiment of the present invention.

FIGS. 6A and 6B show TEM images of gamma-Al₂O₃ nanoparticles in accordance with an embodiment of the present invention.

FIG. 6C shows SEM-EDX images of gamma-Al₂O₃ nanoparticles in accordance with an embodiment of the present invention.

FIG. 7 shows the Fourier transform infra-red spectroscopy (FTIR) spectra of the acrylate formulation and the polymer film in accordance with an embodiment of the present invention.

FIGS. 8A and 8B show the “RCA” tool for testing the wear/abrasion resistance of the polymer film on release paper, the A and B designation of the figures being provided in the image.

FIG. 8C shows the image of a typical hole generated on the polymer surface after the test in accordance with an embodiment of the present invention, the C designation of the figure being provided in the image.

FIG. 9 shows a typical depth profile of the hole/crate created by the “RCA” tool in accordance with an embodiment of the present invention.

FIG. 10 shows the comparison of the relative wear depth of the release paper containing different nanoparticles (where baseline is unit of one) in accordance with an embodiment of the present invention.

FIG. 11 shows the “MIT” folding tester for mechanical folding endurance of release paper under fixed loading conditions in accordance with an embodiment of the present invention, a first image thereof showing the tester in general, and a second image thereof showing a close up of the portion circled in the first image.

FIG. 12 shows a typical comparison of the number of folding from “MIT” folder tester vs. the number of usage for Semi-PU coating processing in accordance with an embodiment of the present invention.

FIG. 13 is a table showing the stability of nanoparticles (γAl₂O₃₋MEMO, STUP-MEMO, ZnO, ZnO-MEMO and MP1040) in 1% (w/w) acrylate formulation.

FIG. 14 is a table showing the effect of γAl₂O₃ nanoparticles concentration on their stability in acrylate formulation.

### DESCRIPTION OF THE EMBODIMENTS

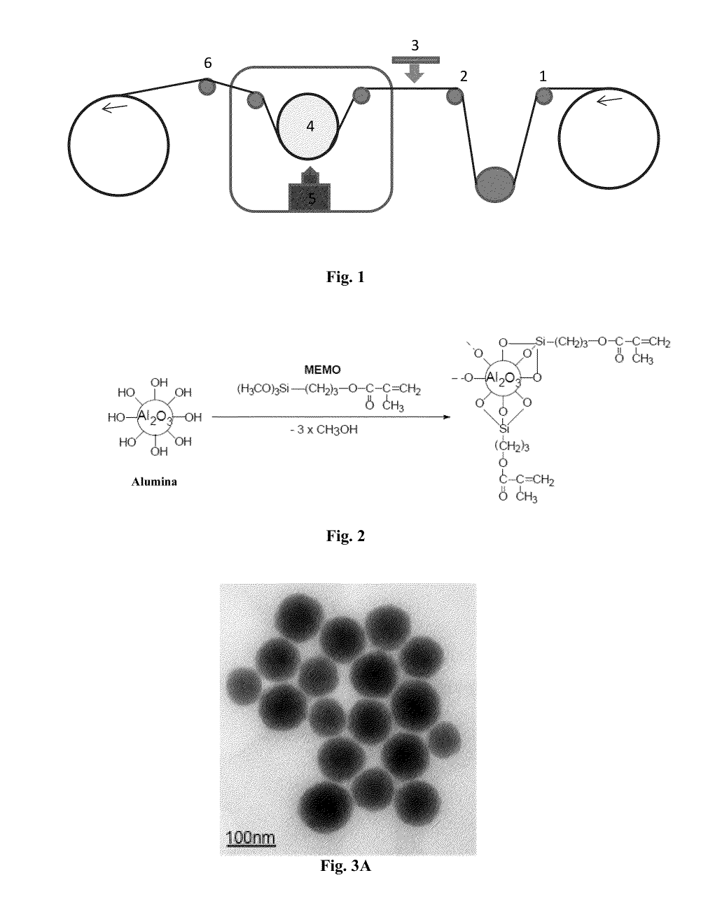

The present invention relates to a method of preparing a coating formulation for processing a release sheet and a method of processing a release sheet. Specifically, the invention relates to a method of preparing a coating formulation for processing a release paper and a method of processing a release paper for use in the synthetic leather industry. In general, the method of processing a release paper involves coating of a polymer layer onto one or both surfaces of a substrate, for example a paper or plastic film, so as to improve the mechanical properties such as strength, abrasion resistance and durability of the release paper. Referring to FIG. 1, there is illustrated an embodiment of the method of processing release paper in accordance with the present invention.

In FIG. 1, selected base paper as a substrate is placed in a starting roller that standard width (1.5 meter wide) paper is flatted (as shown in step 1 of FIG. 1). This base paper is taken by the second roller into the inlet of the electron beam (e-beam) coater (as shown in step 2 of FIG. 1). Pre-mixed coating formulation is added to the front side of the base paper before entering to e-beam coater (as shown in step 3 of FIG. 1). A stainless steel drum with either smooth or textured surface is pressed against the coating formulation onto the front surface of the base paper (as shown in step 4 of FIG. 1). Best known e-beam coating conditions are applied to the back of the base paper to cure the coating formulation on the front surface of the base paper (as shown in step 5 of FIG. 1). Alternatively, the curing can be provided by ultraviolet light (UV) radiation. On the outlet of the e-beam coater, the release paper with polymer coating on the base paper is produced (as shown in step 6 of FIG. 1). This standard width release paper is flattened and rolled back into either 100 meters length for initial sampling or 2000 meters length for full production of synthetic leather. Specifically, pre-mixed coating formulation of step 3 is an acrylate formulation which comprises acrylate monomer, acrylate oligomers and releasing agent.

The releasing agent can be any commonly known releasing agents available in this technical field and are applicable for use in this purpose. The composition of the current releasing agent being used in this specific embodiment is a trade secret that belongs to the suppliers (such as Sartomer USA, LLC, Cytec Specialty Chemicals, and DOW Chemicals).

The structures of the acrylate monomer and examples of the possible acrylate oligomers being used in the monomer composition are illustrated as follows:

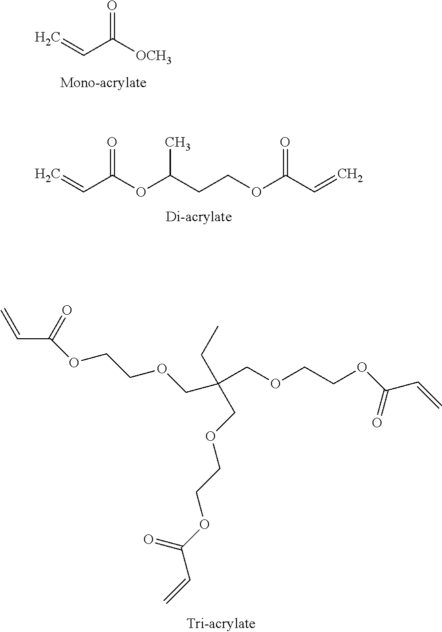

The presence of the oligomers reduces the glass-rubber transition temperature (Tg) of the cured polymer film to reduce brittleness. The presence of the oligomers also increases the viscosity of the acrylate formulation, so that when the formulation is spread on the base paper for e-beam curing, the liquid will stay on the paper surface instead of dripping off or being absorbed into the paper tissue.

The monomer composition further comprises nanoparticles to improve the mechanical properties of the resulting polymer layer and thus the polymer coated release paper. Nanostructures are known to provide improved mechanical properties when incorporated into polymers, for example, ZrO₂, ZnO and carbon nanotubes are found to improve chemical resistance; GPTMS-ZrO₂, carbon nanotubes, MEMO-ZrO₂ and MEMO—SiO₂ are found to improve surface hardness; MEMO—SiO₂, carbon nanotubes, TiO₂—ZrO and CaCO₃ are found to improve wear resistance, and that MEMO-ZrO₂, CaCO₃, Ag-Epoxy and SiO₂ and ZnO are found to improve thermal property of polymer composite with the nanostructures are introduced. In this embodiment, nanoparticles include nano-sized spherical SiO₂, rod-shape SiO₂, ZnO, and preferably, alumina (Al₂O₃) nanoparticles are incorporated into the monomer composition.

It is also known that the inclusion of inorganic nanoparticles into an organic polymer matrix creates compatibility issues. To address these issues, the embodied nanoparticles are surface-modified to provide functional groups on the particle surfaces. FIG. 2 illustrates the surface modification of the alumina nanoparticles of a specific embodiment of the invention. Specifically, 3-(trimethoxysilyl) propyl methacrylate (MEMO) has been used as a silane coupling agent for grafting a silane layer onto the nanoparticles. Each of the silane molecules has an acrylate end group which allows the relatively hydrophilic alumina nanoparticles to become more compatible with the relatively hydrophobic acrylate formulation, and thus stabilizing the nanoparticles in the acrylate matrix. The structure of the MEMO is illustrated below:

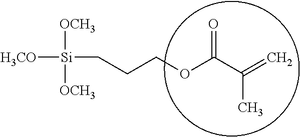 [SMILES: C=C(C)C(=O)OCCC[Si](OC)(OC)OC]

3-(Trimethoxysilyl) propyl methacrylate (MEMO)

Specifically, Al₂O₃ nanoparticles are found to provide a higher MEMO grafting percentage than other nanoparticles and thus an improved stability in the acrylate formulation and a more controllable viscosity of the resulting formulation. On the other hand, silica nanoparticles generally fail to offer a controllable and suitable viscosity when dispersed in the acrylate formulation, and therefore are more susceptible to separation from the acrylate formulation.

After the surface modification, the MEMO-modified nanoparticles were purified and finally be dispersed in IPA. Small amount of the nanoparticle dispersion was vacuum dried, and the quantity of the nanoparticles was characterized. The purified nanoparticle dispersion was introduced into the acrylate formulation. The IPA was then removed under vacuum. This process results in a homogenous nanoparticle dispersion in the acrylate formulation which is highly stable and solvent free. The absence of solvent in the formulation facilitates bulk polymerization in the later step of release paper processing.

Due to their relatively higher density, the nanoparticles tend to precipitate out from the acrylate formulation. It is therefore desirable to allow a relatively higher viscosity of the acrylate formulation to ensure stability of the nanoparticles in the formulation. The preferred viscosity is generally dependent on the specific application of the resulting release paper. Preferably, concentration of the nanoparticles in the acrylate formulation is of less than or equal to about 3 wt % to achieve a desirable viscosity. As an example, for an acrylate formulation without nanoparticles having a viscosity of about 700 cP at ambient condition, the optimum range of viscosity of the formulation after addition of the nanoparticles should be maintained at about 700-1000 cP.

Experimental procedure for the modification, purification, and characterization of the nanoparticles of a specific embodiment is explained as follows. In addition to Al₂O₃ (gamma-Al₂O₃), spherical SiO₂ (MP1040), rod-shape SiO₂ (STUP), ZnO nanoparticles have also been surface modified under the same process and incorporated into the acrylate formulation for coating film substrates in the later steps.

### Experimental Procedure

### Nanoparticles Modification:

1. Measure the solid content of gamma-Al2O3 nanoparticle/water suspension (Purchased from Xuan Cheng Jing Rui New Material Co., Ltd. in China, with concentration of Al₂O₃ is approximately 20% (w/w)).
2. Transfer 5.00 kg of nanoparticle/water suspension, equivalent to 1.00 kg of nanoparticle into a 5 L beaker.
3. Heat the suspension at 55° C. for 16 hr on a hot plate inside a fume hood for water evaporation to increase the solid content to 30% (w/w) with intensive mechanical stirring to avoid aggregation of the nanoparticles. If aggregation happens, add a minimum amount of deionised water to redisperse the nanoparticles in an ultrasonic bath. The final weight of the nanoparticle suspension should be approximately 3.33 kg (1.00 kg/30%).
4. Transfer 525 ml of 2M NaOH solution into the nanoparticles with intensive mechanical stirring. The addition of NaOH solution will follow with an immediate increase of viscosity. Continue stirring of the thickened suspension until the suspension becomes a smooth paste of nanoparticle mixture.
5. Start heating the mixture under a constant temperature of 70° C., with the vapor being condensed by a condenser.
6. Transfer 2870 ml of ethanol into the mixture and allow the temperature to increase to 70° C. again. Stir intensively to disperse the nanoparticles until homogeneous. When the actual temperature reaches 70° C., add 250 g of 3-(Trimethoxysilyl) propyl methacrylate (MEMO) to start the reaction, with a reaction time of approximately 24 hr.
7. Immediately after adding MEMO, transfer 5417 ml of iso-propanol dropwise into the reaction mixture using dropping funnel. The duration of addition is about 1 hr.
8. Cool down the reaction mixture by reducing the temperature of the water circulator. Keep stirring the reaction mixture while cooling.
9. Pour out and measure the solid content of the reaction mixture.

### Nanoparticles Purification Using Ultrafiltration Device:

1. The ultrafiltration device is designed for the nanoparticles with overall particle sizes of 0.45 micron and larger.
2. Rinse the device thoroughly with de-ionised water followed by iso-propanol (IPA).
3. Pour the reaction mixture of nanoparticle suspension into the device. Add IPA until the total volume is equal to or more than 12 L.
4. Circulate the reaction mixture in a stainless steel container with a mechanical pump connected to the filtration columns. The reaction mixture is then passed through the designed piping from the stainless steel container to the filtration columns back to the stainless steel container with cooling if necessary. Remove the filtrate. Circulate until no filtrate flows out.
5. Add 10 L of IPA to rinse the nanoparticles for the first time.
6. Repeat step 4.
7. Add 10 L of IPA to rinse the nanoparticle for the second time.
8. Repeat step 4.
9. Add 10 L of IPA to rinse the nanoparticle for the third time.
10. Repeat step 4.
11. Collect the purified nanoparticles. Add 4 L of IPA to rinse residual nanoparticles inside the device and circulate for about 5 s.
12. Repeat step 11.

Note: It is important to complete this process within one day as the nanoparticles should not be left inside the device overnight which might otherwise leading to aggregation of the nanoparticles and blockage of the device.

### Vacuum Distillation:

1. Determine the solid content of the purified nanoparticle suspension.
2. Transfer a determined amount of nanoparticle suspension and acrylate monomer solution into a distillation tank. Connect the distillation tank with a mechanical stirrer and a condenser. And connect a chiller and a vacuum pump to the condenser.
3. Heat the mixture to 40° C. with stirring at about 100 rpm and pre-cool the chiller to about −20° C.
4. Start cooling the condenser at about −20° C. and apply vacuum to being vacuum distillation. The evaporated IPA will be condensed and be collected in the tank below the condenser.
5. Remove the IPA in the tank when it is full. Continue the vacuum distillation until no IPA is distilled out.
6. Collect the nanoparticle/monomer solution dispersion.
7. Add and stir a determined amount of oligomer solution and releasing agent into the dispersion in a mechanical mixer (or a homogenizer, if possible).

### Measuring Nanoparticles Content:

1. Evenly disperse the nanoparticles suspension by intensive stirring.
2. Weight an empty pan=(a)
3. Pipette 1.00 ml of nanoparticle suspension and weight again=(b) Weight of nanoparticle suspension=(b−a)
4. Dry the suspension on a hot plate and weight it again=(c) Weight of nanoparticles=(c−a)
5. Solid content of nanoparticle suspension: (w/w)=(c−a)/(b−a)*100%
   (w/v)=(c−a)/1*100%

### Characterization of Nanoparticles in the Acrylate Formulation

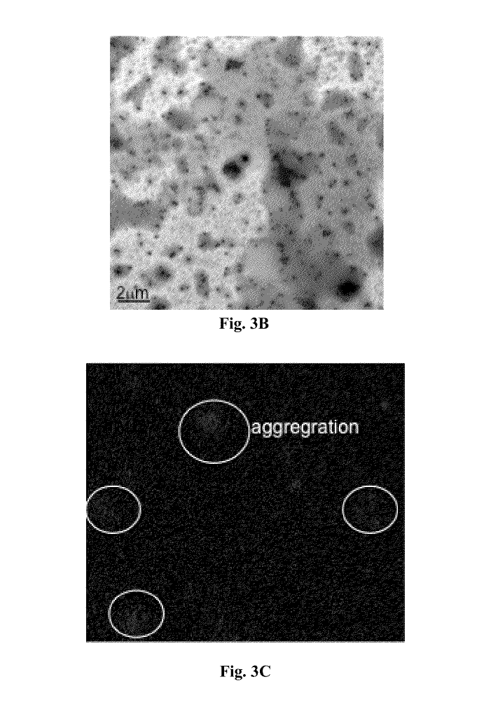

FIGS. 3A and 3B show the Transmission Electron Micrograph (TEM) of the MEMO surface modified spherical SiO₂ (MP1040-MEMO) nanoparticles dispersion. It is illustrated that the MP 1040-MEMO nanoparticles are of a spherical morphology with an average diameter of about 80-120 nm. FIG. 3C is a Scanning Electron Micrograph—Energy-dispersive X-ray spectroscopy (SEM-EDX) micrograph showing distribution of the MP1040-MEMO on the film substrate after the MP1040-MEMO/acrylate formulation has been coated and cured onto the film substrate. The MEMO-modified nanoparticles containing release paper with polymer side facing up was mounted on metal stubs and sputter coated with a thin gold layer. Mapping of elemental Si and C on MEMO-modified nanoparticles containing release paper surfaces was performed by EDX to visualize the actual distribution of Si over the entire surface. While doing Si mapping, a different mode of operation was selected to get the elemental mapping.

To determine the MEMO content on the SiO₂ nanoparticle surfaces, EDX elemental analysis was used. The MEMO-modified nanoparticles being suspended in iso-propanol was dropped onto a polypropylene substrate and was air-dried. The substrate was then mounted on a metal stub and sputtered with a thin gold layer. The mole and mass ratios of Si and C were determined and the MEMO content of the modified nanoparticles can be calculated. This EDX analysis quantified nearly all the elements with a minimum detection limit of 0.0 wt %. These analyses were repeated at three separate locations on each surface and mean surface concentration of elements, such as silicon and carbon from MEMO and aluminum from Al₂O₃ nanoparticle were reported. The low content of MEMO coating will result in higher aggregation of the nanoparticles, which are shown by the white circles in FIG. 3C.

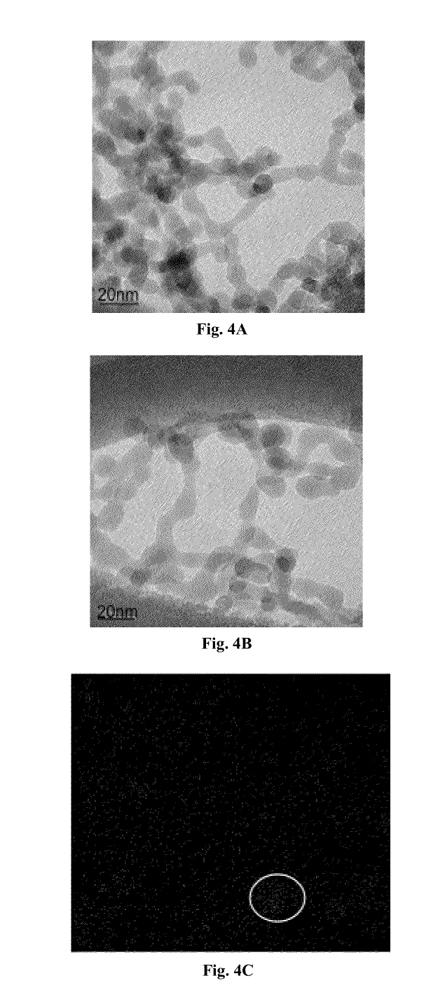

FIGS. 4A and 4B show the TEM of the MEMO surface modified rod-shape SiO₂ (STUP-MEMO) nanoparticles dispersion. It is illustrated that the STUP-MEMO are of a string of pearl like morphology, with an average width of 10 nm. FIG. 4C is a SEM-EDX micrograph showing distribution of the STUP-MEMO on the film substrate after the STUP-MEMO/acrylate formulation has been coated and cured onto the film substrate. Content of the MEMO coated on the STUP is approximately 150 mg/g of STUP. The higher detectable content of MEMO may facilitate an evener distribution of the nanoparticles in the acrylate formulation.

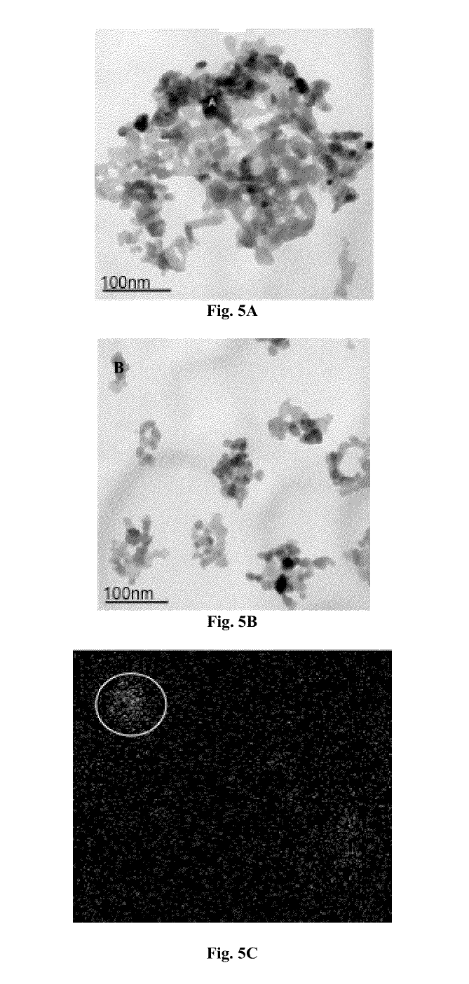

FIGS. 5A and 5B show the TEM of the MEMO surface modified ZnO (ZnO-MEMO) nanoparticles dispersion. It is illustrated that the ZnO-MEMO are irregularly spherical in shape having a diameter of about 10-20 nm. FIG. 5C is a SEM-EDX micrograph showing distribution of the ZnO-MEMO on the film substrate after the ZnO-MEMO/acrylate formulation has been coated and cured onto the film substrate. Mapping of elemental Zn on MEMO-modified nanoparticles containing release paper surfaces was performed by EDX to visualize the actual distribution of Zn over the entire surface. The mole and mass ratios of Zn, Si and C were determined by EDX. Content of the MEMO coated on the ZnO is approximately 53 mg/g of ZnO. The lower content of MEMO may due to the lower amount of OH-group on the ZnO surface.

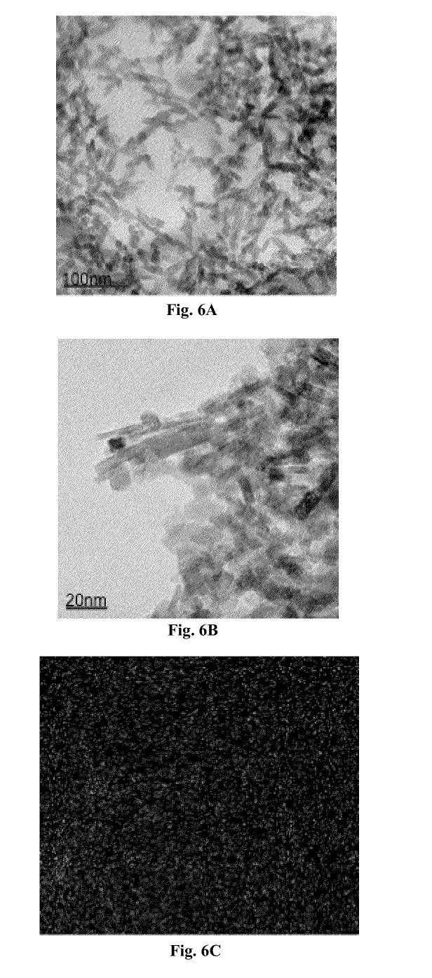

FIGS. 6A and 6B show the TEM of the MEMO surface modified gamma-Al₂O₃ nanoparticles (γAl₂O₃₋MEMO) dispersion. It is illustrated that the γAl₂O₃₋MEMO are both rod shape and irregularly spherical in shape having a width of approximately 10 nm. FIG. 6C is a SEM-EDX mapping micrograph showing distribution of the γAl₂O₃₋MEMO on the film substrate after the γAl₂O₃₋MEMO/acrylate formulation has been coated and cured onto the film substrate. Mapping of elemental Al on MEMO-modified nanoparticles containing release paper surfaces was performed by EDX to visualize the actual distribution of Al over the entire surface. The mole and mass ratios of Al, Si and C were determined by EDX. Content of the MEMO coated on the γ-Al₂O₃ is approximately 85 mg/g of γ-Al₂O₃. Although the content of MEMO is not the highest among the four tested samples, the γAl₂O₃₋MEMO nanoparticles shows the best distribution, which is probably due to the shape of the nanoparticles. It is because there are random sizes and shapes of the gamma-alumina nanoparticles which allow the nanoparticles to precipitate at a slower rate.

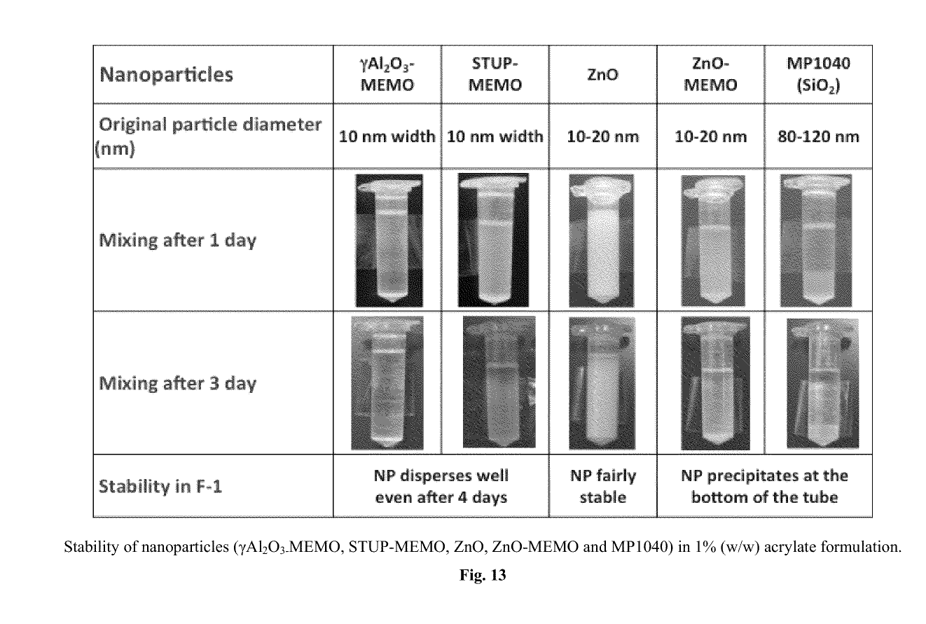

FIG. 13 provides a table that shows the stability of five different nanoparticles being dispersed in the acrylate formulation in a concentration of 1% (w/w). By comparing different MEMO-modified nanoparticles, it is shown that different stability of the nanoparticles in the formulation is exhibited. For particles with larger particle sizes, the MEMO-modified nanoparticles tend to precipitate at the bottom to give separate layers. On the other hand, it is found that MEMO-modified gamma-Al₂O₃ nanoparticles demonstrate the best stability which shows a homogenous turbid appearance in the control acrylate formulation (F-1) without separation after 4 days.

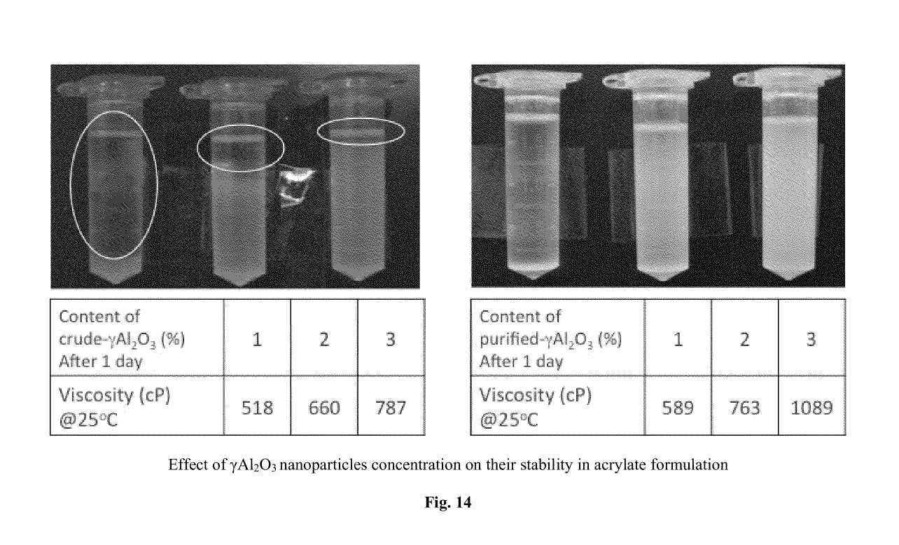

FIG. 14 further shows the effect of nanoparticles concentration on their stability in the acrylate formulation. In this case, viscosities of acrylate formulation with different MEMO-modified nanoparticles contents are compared. It is expected that the viscosity increases with the higher nanoparticles concentration and thus better stability in the formulation. It is also shown that the purified nanoparticles have better stability in the acrylate formulation than the crude (unpurified) nanoparticles.

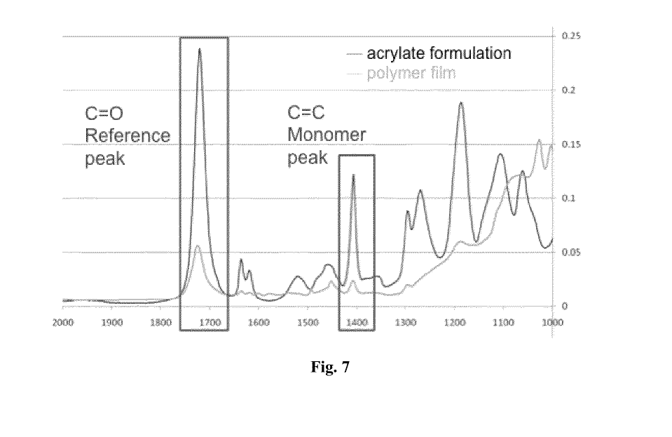

FIG. 7 shows the conversion of acrylate monomer as measured by a Fourier Transform Infra Red Spectroscopy (FTIR). Monomers contain C═C bonds for polymerization. In the reaction, individual C═C bonds polymerize into long C—C chains and causes decrement of C═C concentration. The lower the C═C concentration, the higher the monomer conversion is. Being not participate to the polymerization reaction, C═O concentration remains the same and can be used as the reference in calculation of monomer conversion. Conversion of the acrylate monomer can be determined by the following equation:

$$Conversion = ( 1 - \frac{C = C}{C = O} \times \frac{C = {O}_{o}}{C = {C}_{o}} ) \times 100 \%$$

in which C═C is the concentration of C═C after curing, C═O is the concentration of C═O after the curing, C═Cₒ is the initial concentration of C═C before curing, and C═Oₒ is the initial concentration of C═O before curing.

Table 1 below shows comparisons between controlled formulation (F-1, without nanoparticles) and nanoparticles (NP)-blended formulation. In Table 3, the monomer conversions of different polymer coatings on the release paper are shown. Since the samples were produced by electron beam (e-beam) coating equipment, two e-beam coating conditions have been tested, and the dosage of the e-beams are compared using MR unit. It is revealed that the presence of nanoparticles does not significantly affect on conversion of the acrylate monomers. In addition, dosage of the electron beam also does not appear to significantly affect the conversion of the acrylate monomers.

TABLE 1
Comparisons of monomer conversions between controlled formulation
(F-1, acrylate formulation without nanoparticles) and
nanoparticles (NP)-blended formulation.

| Sample | Conversion (%) | condition |
|---|---|---|
| control (no NP blended) | 79 | under same |
| 3% MP1040-MEMO | 77 | e-beam condition |
| 0.64% ZnO | 76 | |
| 1% ZnO-MEMO | 76 | |
| F-1, 3.3MR | 78 | comparison |
| F-1, 3MR | 80 | between |
| 2% γAl₂O₃ - MEMO | 81 | 2 e-beam |
| purified, 3.3MR | | conditions |
| 2% γAl₂O₃ - MEMO | 79 | |
| purified, 3MR | | |

### Testing of Mechanical Properties of the Nanoparticle/Acrylate Formulation Coated Film Substrate

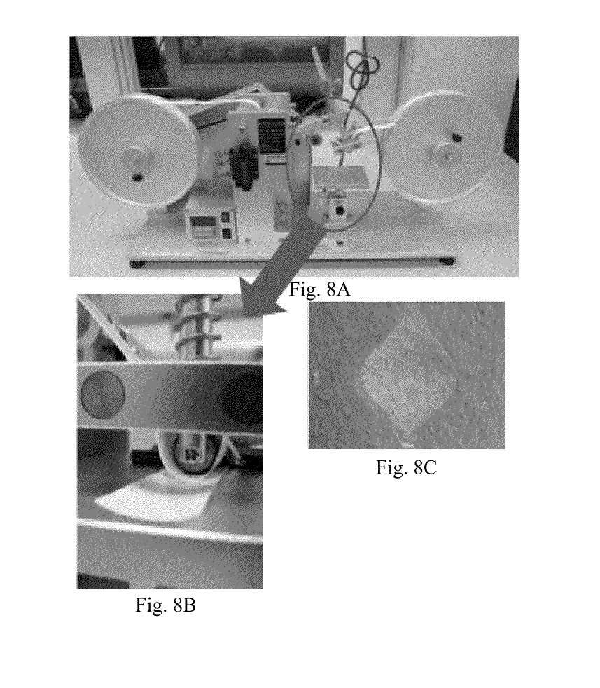

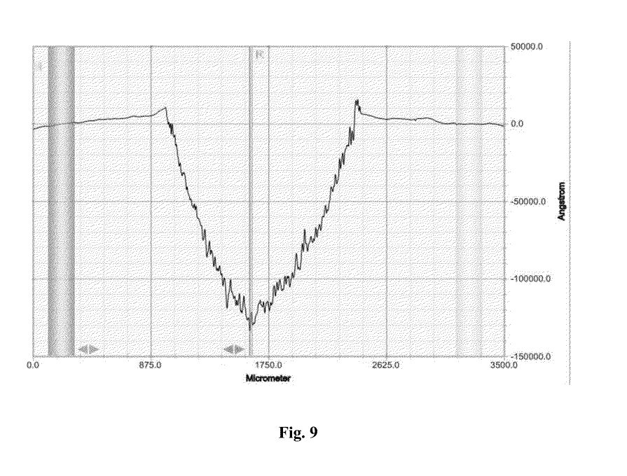

One reason for incorporating nanoparticles into the acrylate formulation is to increase the mechanism strength and abrasion resistance of the polymer coating of the resulting release paper. In one specific embodiment, RCA method (based on ASTM's developed test method for determining the abrasion resistance of coatings using the Norman Tool, Inc. “RCA” Abrader; RCA Abrasion Wear Tester model number 7-IBB-CC) has been used to create small holes on the polymer coating, and the wear depth of the small holes are measured by alpha step surface profiler (Tensor Model P-10 Surface Profiler). A typical setup of the RCA test is shown in FIGS. 8A and 8B. Specifically, samples were subjected to rubbing against paper scripts with rough surfaces (RCA designated paper roll) under a fixed number of cycles (see FIG. 8B). For the specific embodiment as shown in FIG. 8, a sample with a size of 1.5 cm×7.5 cm was subjected to an abrasion cycle of 50 under a loading of 275 g. A small concavity was then produced after such abrasion and the depth of the concavity was measured. FIG. 8C shows one of the concavity resulted from the mechanical rubbing. The lower the depth measured, the better is the abrasion resistance of the coating. Accordingly, the abrasion resistance can be compared for the performance of different nanoparticles incorporated polymer coatings. A typical wear depth profile is shown in FIG. 9 which reveals a wear depth of about 13 μm. The relative wear depth is calculated based on the following equation:

$$Relative wear depth = \frac{wear depth of sample measured}{wear depth of F \text{-} 1}$$

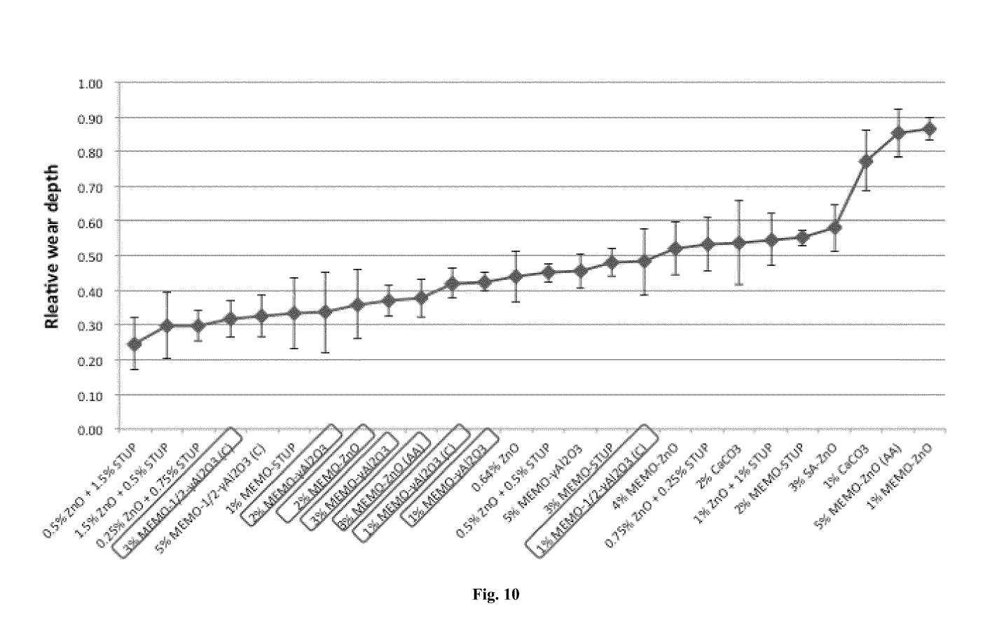

The relative wear depths against acrylate polymer coatings incorporated with different nanoparticles are shown in FIG. 10. Measurements of the wear depth were compared with the control base line polymer coating samples using F-1 formulation without nanoparticle. Thus, the control base line of the relative wear depth is one, and less than one would mean the sample has a better wear/abrasion resistance than the control. In FIG. 10, results of 26 different formulations and conditions using different nanoparticles are shown. For example, 3% MEMO-½Al₂O₃ represents three weight percent of MEMO-modified Al₂O₃ added with half of the MEMO during synthesis. As previously mentioned, the smaller the relative wear depth, the better the abrasion resistance of the tested sample. Samples with better abrasion resistance such as those with gamma-Al₂O₃ nanoparticles were selected for electron beam curing and pilot scale production.

Performance Test on gamma-Al₂O₃-MEMO Nanoparticles/Acrylate Polymer Coated Release Paper After Processing with Polyurethane Production

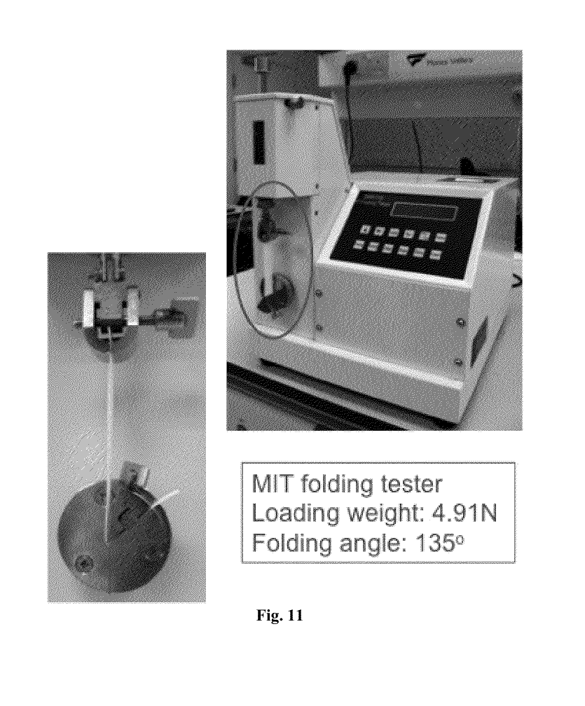

For release paper being used in the synthetic leather industry, it is generally required to possess good heat resistance, good durability, and less curling tendency after repeated use. The performance of 2% gamma-Al₂O₃-MEMO nanoparticles/acrylate polymer coated release paper as prepared in the abovementioned embodiments is tested by using a MIT folding tool invented by the Massachusetts Institute of Technology. As shown in FIG. 11, the tool is loaded with a weight of 4.91 N and a folding angle of 135°. Prior testing, the sample release paper has been sent to a synthetic leather company for making semi-PU leather. For each leather production cycle, the release paper is coated with a layer of PU followed by a layer of PVC on the same side. Then a base cloth is attached and the whole semi-PU leather is torn off.

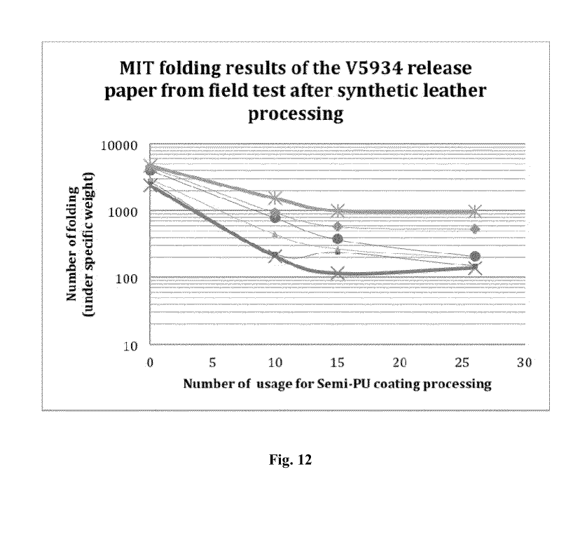

The process has been conducted repeatedly on the same release paper, with the number of uses indicated at the x-axis of FIG. 12. Six parallel tests have been conducted with the 2% gamma-Al₂O₃-MEMO nanoparticles/acrylate polymer coated release paper by the MIT folding tool. According to the results, it is concluded that nanoparticles modified acrylate polymer coating shows minor effect in improving folding endurance.

1. A method of preparing a coating formulation for use in processing a release sheet, comprising steps of:
a. providing nanoparticles;
b. treating the nanoparticles to give surface-modified nanoparticles; and
c. introducing the surface-modified nanoparticles into a monomer composition.

2. The method according to claim 1, further comprising step of purifying the surface-modified nanoparticles after step b.

3. The method according to claim 1, further comprising step of dispersing the surface-modified nanoparticles into a solvent to form a surface-modified nanoparticles dispersion prior to step c.

4. The method according to claim 1, wherein the monomer composition comprises at least one of acrylate monomers, acrylate oligomers, releasing agent or a mixture thereof.

5. The method according to claim 1, wherein the treating step comprises surface modifying the nanoparticles by using saline coupling agent.

6. The method according to claim 5, wherein the saline coupling agent comprises 3-(trimethoxysilyl) propyl methacrylate.

7. The method according to claim 1, wherein the treating step comprises introducing acrylate groups onto surface of the nanoparticles.

8. The method according to claim 1, wherein the nanoparticles are selected from a group consisting of aluminum dioxide, silicon dioxide and zinc oxide nanoparticles and a mixture thereof.

9. The method according to claim 1, wherein the nanoparticles are of less than or equal to about 3 wt % in the monomer composition.

10. The method according to claim 3, further comprising a step of removing the solvent after the incorporating step.

11. The method according to claim 3, wherein the solvent is isopropanol.

12. The method according to claim 1, wherein the surface-modified nanoparticles are of a diameter of about 10 nm to 120 nm.

13. The method according to claim 1, wherein the coating formulation after step c is of a viscosity of about 700 to 1000 cP at ambient condition.

14. The method according to claim 1, wherein the nanoparticles are spherical, rod-like, a string of pearl like, or a mixture thereof.

15. A method of processing a release sheet, comprising:
i. coating a coating formulation onto a surface of a sheet substrate; and
ii. curing the coating formulation to form a polymer-coated sheet substrate, wherein the coating formulation is prepared by the method comprising steps of:
a. providing nanoparticles;
b. treating the nanoparticles to give surface-modified nanoparticles; and
c. introducing the surface-modified nanoparticles into a monomer composition.

16. The method according to claim 15, wherein the curing step comprises radiating of electron beam or ultra-violet light.
